(19) United States
(12) Patent Application Publication
(10) Pub. No.: US 2023/0092179 A1
(43) Pub. Date: Mar. 23, 2023

(54) HEATER ASSEMBLY AND CARTRIDGE

(71) Applicants: SHENZHEN EVERWIN PRECISION TECHNOLOGY CO., LTD., SHENZHEN (CN); DONGGUAN ALPHA ELECTRONIC TECHNOLOGY CO., LTD., DONGGUAN (CN)

(72) Inventor: ZHIAN HE, SHENZHEN (CN)

(21) Appl. No.: 18/059,991

(22) Filed: Nov. 30, 2022

Related U.S. Application Data
(63) Continuation of application No. PCT/CN2021/079063, filed on Mar. 4, 2021.

(30) Foreign Application Priority Data
Sep. 21, 2020 (CN) 202010994538.4
Nov. 18, 2020 (CN) 202011292505.1
Nov. 18, 2020 (CN) 202022682634.3

(51) Int. Cl. A24F 40/48; A24F 40/10; A24F 40/46; A24F 40/42; H05B 3/06

(52) U.S. Cl. CPC A24F 40/48; A24F 40/10; A24F 40/46; A24F 40/42; H05B 3/06; H05B 2203/016

(57) ABSTRACT

A heating assembly includes a closure member, an atomizing core, and a sealing member sleeved on the atomizing core and clamped between the atomizing core and the closure member. The closure member includes a main body portion, e-liquid passages and an air passage defined on the main body portion and being independent of each other, an accommodation cavity disposed below the e-liquid passages and in communication with the e-liquid passages, and a part of an atomizing cavity disposed below the accommodation cavity. The atomizing core includes a seepage surface in communication with the e-liquid passages, and an atomizing surface in communication with the atomizing cavity. The sealing member includes a packing portion closely attached to an interior of the accommodation portion. The packing portion includes a packing wall and a covering portion. A cartridge is further provided.

### CROSS-REFERENCE TO RELATED APPLICATIONS

The present disclosure claims the priority of Chinese Patent Application No. 202010994538.4, filed Sep. 21, 2020 and entitled “Cartridge and Electronic Cigarette”, the entirety of which is hereby incorporated herein by reference for all purposes. Besides, the present disclosure claims the priority of Chinese Patent Application No. 202011292505.1, filed Nov. 18, 2020 and entitled “Heating Assembly and Cartridge”, and Chinese Patent Application No. 202022682634.3, filed Nov. 18, 2020 and entitled “Atomizing Core and Cartridge”, the entirety of which are hereby incorporated herein by reference for all purposes.

### TECHNICAL FIELD

The present disclosure relates to a technical field of electronic cigarettes, and in particular to a heating assembly and a cartridge.

### BACKGROUND

Patent Application No. 201811033876.0 of the People's Republic of China discloses an atomizer and an electronic cigarette, including a cartridge tube provided with a liquid storage chamber and an air tube, a heating assembly installed in the cartridge tube and closing the liquid storage chamber, an atomizing core disposed below the heating assembly, and a base snapped into the cartridge tube and disposed below the heating assembly. The heating assembly includes a hard plastic member and a sealing member sleeved on a corresponding part of the hard plastic member. A bottom of the heating assembly is recessed upward to form an installation cavity configured to accommodate the atomizing core, an e-liquid passage running up and down to connect an upper surface of the atomizing core to the liquid storage chamber, and an air passage communicating the air tube to the atomizing cavity below the atomizing core. The sealing member seals a joint between the liquid storage chamber and the hard plastic member, a joint between the air tube and the air passage, and a joint between the atomizing core and the hard plastic member.

The base includes an insulation body and a spring-loaded pin (pogo pin) assembled or formed in the insulation body. There is a gap in a middle between the insulation body and the heating assembly, and an atomizing cavity is defined. The spring-loaded pin is generally fixed in the insulation body by means of assembly or injection molding. A top of the spring-loaded pin abuts against an electrode at a bottom of the atomizing core, and a bottom of the spring-loaded pin is exposed to a bottom surface of the insulation body and in communication with a battery of a cigarette rod. However, the spring-loaded pin generally cannot connect to materials, thus automated material connection production cannot be realized. There is a need to manually place the spring-loaded pin into a mold, and then perform the injection molding. This solution is low in production efficiency and prone to errors, which may easily lead to production safety accidents.

In addition, patent Application No. 201811033876.0 of the People's Republic of China discloses a technical solution in which an air pressure balance is kept in the liquid storage chamber. An air guide passage is defined on a side of the first sealing member close to the atomizing core, to keep the air pressure balance in the liquid storage chamber. However, although the air guide passage has a small gap, there still exists a risk of e-liquid leakage.

### SUMMARY

In view of this, the present disclosure provides a heating assembly and a cartridge which have the performance of maintaining an air pressure balance inside and outside the liquid storage chamber without leakage of an e-liquid; and in addition, can realize high efficiency production through the improvement of the conductive member on the base, thereby reducing the risk of safety accidents.

In order to solve the above problems, the present disclosure provides a heating assembly, including a closure member, an atomizing core, and a sealing member sleeved on the atomizing core and clamped between the atomizing core and the closure member. The closure member includes a main body portion, an e-liquid passage and an air passage that are defined on the main body portion and are independent of each other, an accommodation cavity that is disposed below the e-liquid passage and in communication with the e-liquid passage, and a part of an atomizing cavity that is disposed below the accommodation cavity. The atomizing core includes a seepage surface in communication with the e-liquid passage, and an atomizing surface in communication with the atomizing cavity. The sealing member includes a packing portion that is closely attached to an interior of the accommodation portion. The packing portion includes a packing wall that is clamped between an inner wall surface of the accommodation cavity and a side surface of the atomizing core, and a covering portion that extends integrally from the packing wall and is closely attached to an outer edge of the seepage surface. At least one balance air groove in communication with the atomizing cavity is defined between the packing wall and the side surface of the atomizing core. In a case that there is a predetermined negative pressure value in the e-liquid passage, an external air pressure inside the balance air groove causes the covering portion corresponding to the balance air groove to open and allows external air to enter the e-liquid passage, thereby achieving an air pressure balance.

In order to solve the above problems, the present disclosure further provides a cartridge, including a cartridge tube provided with a flue and a liquid storage chamber, a closure body installed in the cartridge tube and closing the liquid storage chamber, an atomizing core installed in the closure body, and a base fixed to the cartridge tube. A bottom of the closure body is recessed upward to form a cavity body, an e-liquid passage running through the closure body up and down, and an air passage isolatedly disposed from the e-liquid passage. The atomizing core is installed in the cavity body. The flue is in communication with the air passage, and the air passage is in communication with the cavity body below the atomizing core. The atomizing core includes a seepage surface in communication with the e-liquid passage, an atomizing surface exposed in the cavity body, and a heating wire disposed on the atomizing surface. The heating wire includes a heating wire main body, and a first electrode and a second electrode connected to two sides of the heating wire main body. The base includes an insulation base body, and an elastic terminal integrally formed on the insulation base body through injection molding. The elastic terminal includes a contact portion exposed to a bottom surface of the insulation base body and an elastic arm abutting upward against and in electrical contact with the first electrode and the second electrode of the atomizing core.

In order to solve the above problems, the present disclosure further provides a cartridge, including an atomizing core, a tube body, a closure member, a sealing member integrally formed on the closure member, and a base. The atomizing core includes a porous body, extension walls extending upward from two longitudinal sides of the porous body and a transverse through-groove defined between the pair of the extension walls. A seepage surface is formed at a bottom surface of the transverse through-groove, an atomizing surface is formed at a bottom surface of the porous body, and a heating wire is disposed on the atomizing surface. The closure member includes a main body portion, an e-liquid passage and an air passage that are defined on the main body portion and independent of each other, an accommodation cavity disposed below the e-liquid passage and in communication with the e-liquid passage, and a part of an atomizing cavity disposed below the accommodation cavity. The sealing member includes an upper sealing portion and a lower sealing portion clamped between the tube body and the closure member, and a packing portion formed in the accommodation cavity. The packing portion is clamped between the atomizing core and the accommodation cavity. The covering portion includes a packing wall clamped between an outer side surface of the atomizing core and an inner wall surface of the accommodation cavity, and a covering portion extending from the packing wall and pressing against the seepage surface in an interference manner.

According to the heating assembly and the cartridge provided in the present disclosure, the balance air groove in communication with the atomizing cavity is defined on the packing wall of the sealing member, and the covering portion above the balance air groove completely presses against the seepage surface of the atomizing core. As such, when a negative pressure in the liquid storage chamber reaches a certain value, the covering portion is caused to open, so as to allow the air to enter the liquid storage chamber from the atomizing cavity along the balance air groove and the opened covering portion, thereby achieving the air pressure balance in the liquid storage chamber. In addition, the covering portion is closely attached to the seepage surface of the atomizing core when the liquid storage chamber is in a non-negative pressure state, which can effectively prevent e-liquid leakage.

In addition, the sealing member and the closure member are integrally injection molded, so that they are closely combined. Further, the bumps and the fit-in holes are nested with each other, which realizes more close combination between the sealing member and the closure member. This prevents the sealing member from splitting from the closure member, thereby avoiding the quality defects.

According to the base of the cartridge provided in the present disclosure, the elastic terminal is used to replace the conventional spring-loaded pin, which avoids the problem that the spring-loaded pin cannot connect to materials and thereby failing to realize automated production. The elastic terminal connects to the material strip via the material connection portion, so as to realize fully automated injection molding. This greatly reduces labor costs in manufacturing, and enhances production stability, thereby reducing the quality problems caused by human factors.

### BRIEF DESCRIPTION OF THE DRAWINGS

FIG. 1 is a three-dimensional diagram of a cartridge according to one embodiment of the present disclosure.

FIG. 2 is a three-dimensional exploded diagram of a cartridge according to one embodiment of the present disclosure.

FIG. 3 is a cross-sectional diagram of a cartridge tube of a cartridge taken along a dashed line A-A as shown in FIG. 1.

FIG. 4 is a three-dimensional diagram of a heating assembly of a cartridge according to the present disclosure.

FIG. 5 is a three-dimensional diagram of an atomizing core of a cartridge according to one embodiment of the present disclosure.

FIG. 6 is another three-dimensional diagram of an atomizing core of a cartridge according to one embodiment of the present disclosure.

FIG. 7 is a three-dimensional diagram of a base of a cartridge according to one embodiment of the present disclosure.

FIG. 8 is another three-dimensional diagram of a base of a cartridge according to one embodiment of the present disclosure.

FIG. 9 is a three-dimensional diagram of an elastic terminal of a base according to one embodiment of the present disclosure.

FIG. 10 is a cross-sectional diagram of a cartridge taken along a dashed line A-A as shown in FIG. 1.

FIG. 11 to FIG. 18 are drawings showing a heating assembly according to a first embodiment of the present disclosure.

FIG. 11 is another three-dimensional diagram of a heating assembly according to one embodiment of the present disclosure.

FIG. 12 is a three-dimensional exploded diagram of a heating assembly according to one embodiment of the present disclosure.

FIG. 13 is another three-dimensional exploded diagram of a heating assembly according to one embodiment of the present disclosure.

FIG. 14 is a partial enlarged diagram of a dashed circle as shown in FIG. 13.

FIG. 15 is a cross-sectional diagram taken along a dashed line B-B as shown in FIG. 11.

FIG. 16 is a partial enlarged diagram of a dashed circle as shown in FIG. 15.

FIG. 17 is a cross-sectional diagram taken along a dashed line C-C as shown in FIG. 11.

FIG. 18 is a partial enlarged diagram of a dashed circle as shown in FIG. 17.

FIG. 19 to FIG. 21 are drawings showing a heating assembly of a cartridge according to a second embodiment of the present disclosure.

FIG. 19 is a cross-sectional diagram of a heating assembly according to the second embodiment of the present disclosure.

FIG. 20 is a partial enlarged diagram of a dashed circle as shown in FIG. 19.

FIG. 21 is a three-dimensional diagram of a sealing member according to the second embodiment of the present disclosure.

### DETAILED DESCRIPTION OF THE EMBODIMENTS

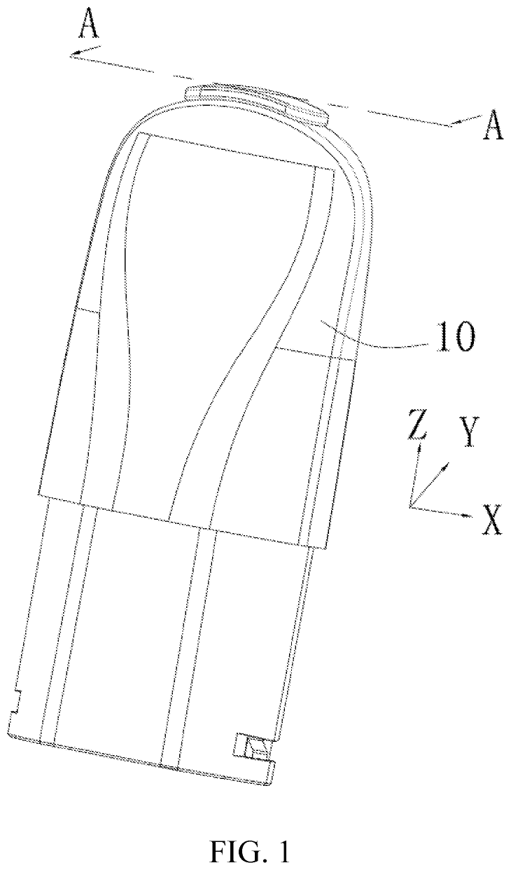

In the present disclosure, as shown in FIG. 1, the X direction is called a left-right direction (transverse direction), the Y direction is called a front-rear direction (longitudinal direction), and the Z direction is called an up-down direction (vertical direction).

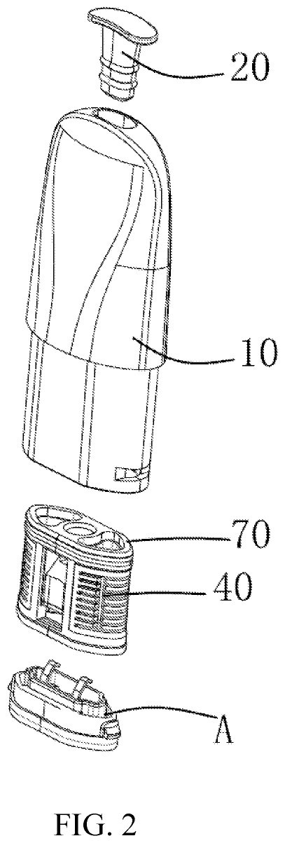

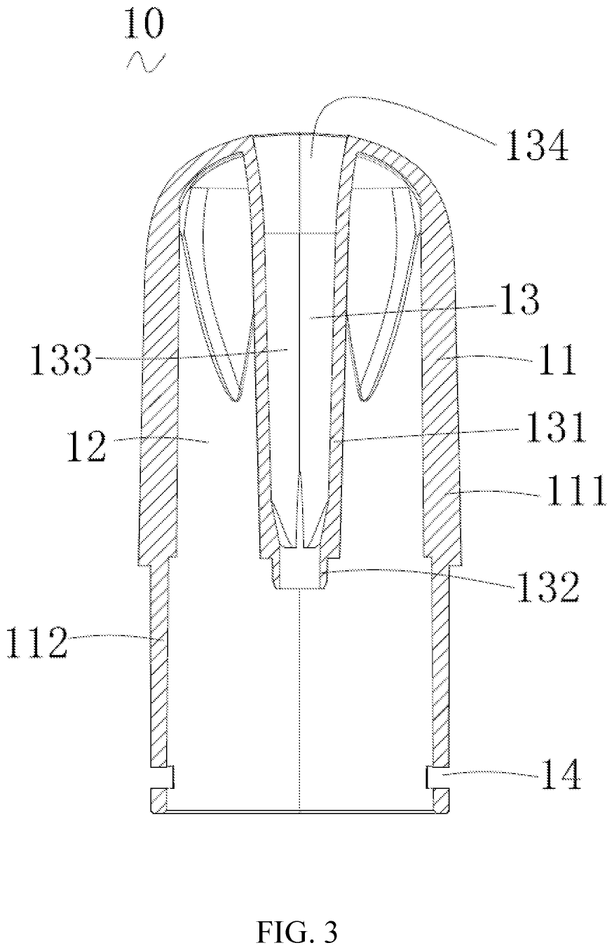

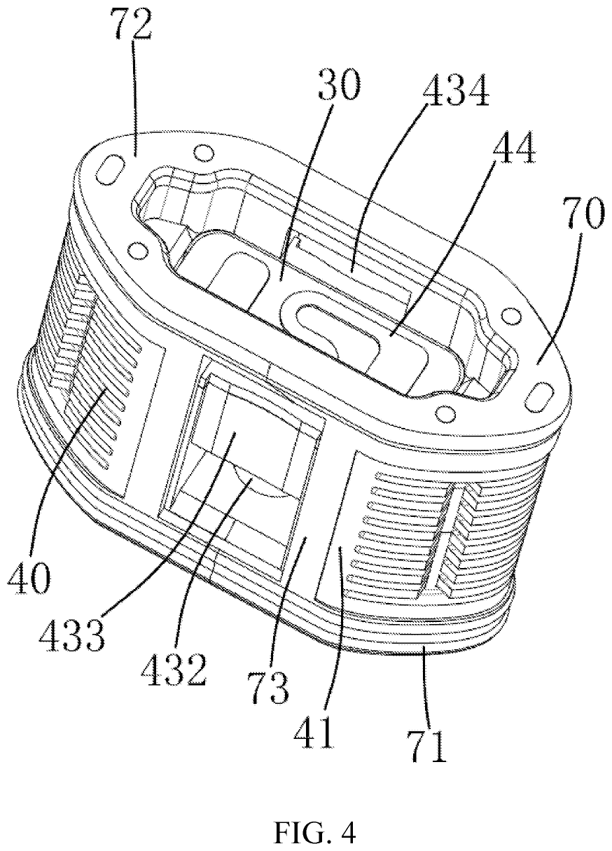

Referring to FIG. 1 to FIG. 4, a cartridge of the present disclosure includes a cartridge tube 10 provided with a flue 13 and a liquid storage chamber 12, a heating assembly installed in the cartridge tube 10 and closing the liquid storage chamber 12, and a base A fixed to the cartridge tube 10.

The cartridge tube 10 includes a tube body 11, the liquid storage chamber 12 located in the tube body 11, the flue 13 disposed in the tube body 11 and running from top to bottom, and first snap-fit portions 14 disposed on two sides of a bottom of the tube body 11. The tube body 11 includes an upper tube body 111 and a lower tube body 112. A wall thickness of the upper tube body 111 is greater than a wall thickness of the lower tube body 112. The first snap-fit portions 14 are disposed on two transverse sides of the lower tube body 112. The flue 13 includes a flue tube 131 extending from a top of the tube body 11 into the liquid storage chamber 12, a smoke hole 133 defined in a middle of the flue tube 131, and an insertion portion 132 formed at a bottom of the flue tube 131. An inhalation port 134 is defined by running through a top of the flue 13. An aperture of the inhalation port 134 is larger than an aperture of the remaining portion of the smoke hole 133. An outer diameter of the insertion portion 132 is smaller than an outer diameter of the flue tube 131. Preferably, the flue 13 is located in a middle of the liquid storage chamber 12. In a specific implementation, the flue 13 may be disposed on one or two sides of the liquid storage chamber 12.

When the cartridge is packaged, the inhalation port 134 is closed by a rubber plug 20, to prevent foreign objects from entering the smoke hole 133 of the flue 13.

The heating assembly includes a closure member 40, a sealing member 70 integrally formed on the closure member 40, and an atomizing core 30 installed in the sealing member 70 and the closure member 40. The heating assembly is inserted into the tube body 11 and blocks the liquid storage chamber 12. An atomizing cavity 44 is disposed below the heating assembly. An accommodation cavity 45 configured to hold the atomizing core 30 is disposed above the atomizing cavity 44. An upper side of the atomizing core 30 is in communication with the liquid storage chamber 12. The heating assembly further includes an air passage 43 that communicates the flue 13 and the atomizing cavity 44.

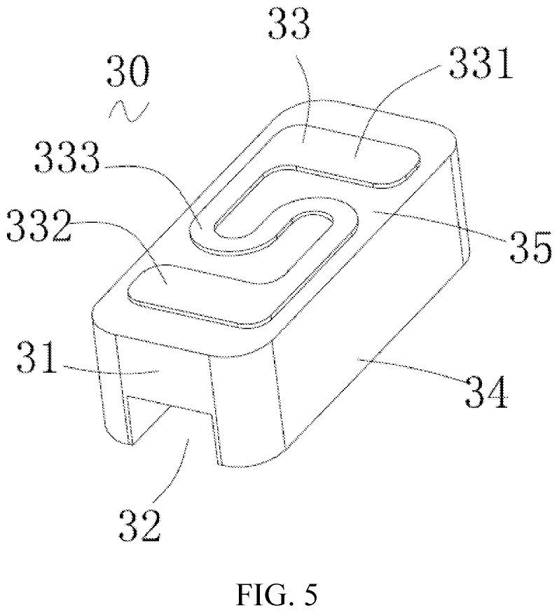

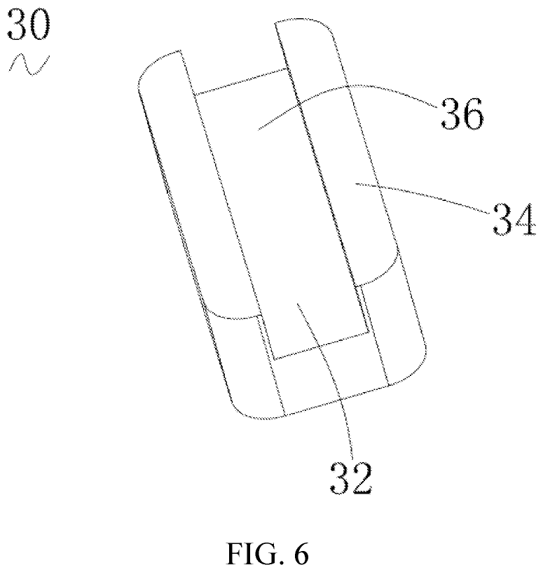

Continuing to refer to FIG. 5 and FIG. 6, the atomizing core 30 includes a porous body 31, extension walls 34 extending upward from two longitudinal sides of the porous body 31, and a transverse through-groove 32 jointly defined by the porous body 31 and the pair of extension walls 34. The transverse through-groove 32 runs through in the transverse direction, with a left side, a right side and an upper side open. A bottom surface and a side surface of the transverse through-groove 32 and/or top surfaces of the extension walls 34 constitute a seepage surface 36 of the atomizing core 30. A bottom surface of the porous body 31 is an atomizing surface 35. A heating wire 33 is embedded in or mounted on the atomizing surface 35. The heating wire 33 includes a heating wire main body 333, and a first electrode 331 and a second electrode 332 connected to the heating wire main body 333 and located on left and right sides. The heating wire main body 333 extends in a S-shaped structure. Widths of the first electrode 331 and the second electrode 332 are greater than a width of the heating wire main body 333.

The sealing member 70 is clamped between an outer periphery of the porous body 31 and the closure member 40 to achieve sealing. A cavity located below the atomizing core 30 forms a part of the atomizing cavity.

Subsequently, the heating assembly is pushed upward into the tube body 11 of the cartridge tube 10. The sealing member 70 is clamped between an inner wall surface of the tube body 11 of the cartridge tube 10 and an outer periphery of the closure member 40, so as to seal the liquid storage chamber 12. In addition, the insertion portion 132 of the flue 13 is inserted into the air passage 43, and the sealing member 70 is clamped between an outer wall surface of the flue 13 and an inner wall surface of the air passage 43, so as to seal the air passage 13, thereby preventing an e-liquid from seeping into the air passage 13. Two transverse ends of the transverse through-groove 32 are in communication with the liquid storage chamber 12, so as to allow the e-liquid in the liquid storage chamber 12 to flow into the transverse through-groove 32. The e-liquid seeps from the seepage surface 36 to a side of the atomizing surface 35. The atomizing core 30 is made of a porous ceramic material or a porous metal material. A plurality of capillary holes are formed between the seepage surface 36 and the atomizing surface 35, and the e-liquid seeps through the capillary holes.

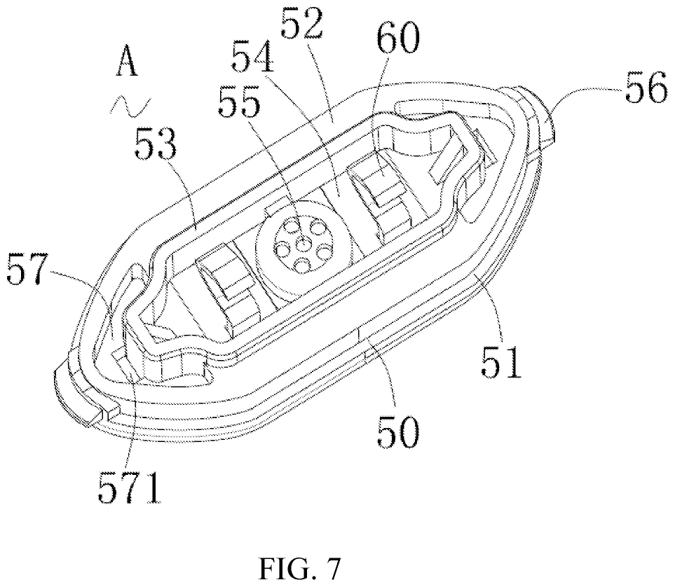

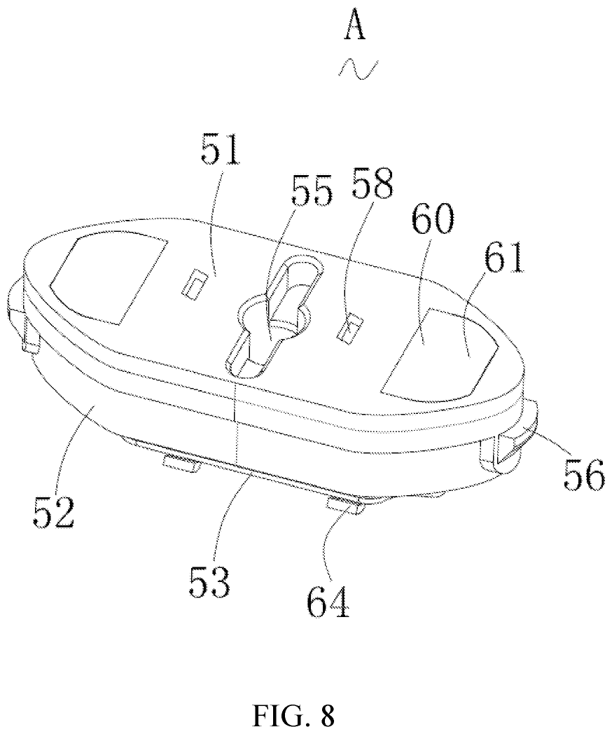

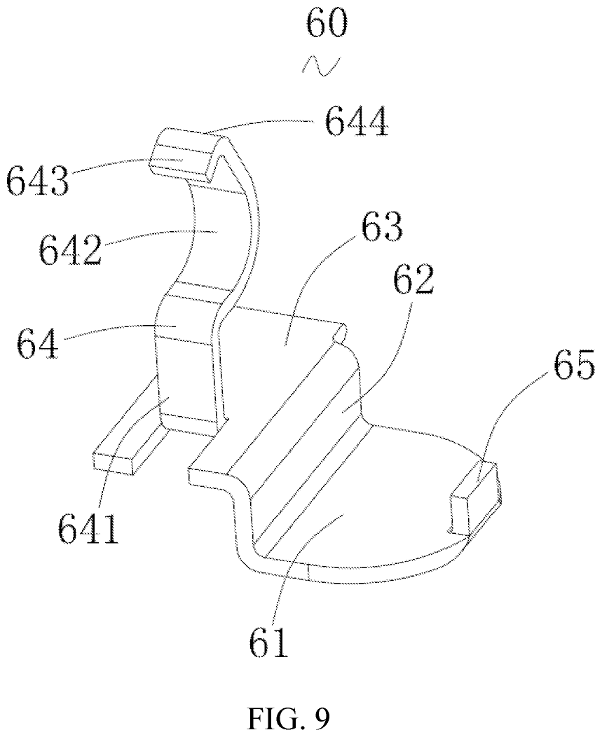

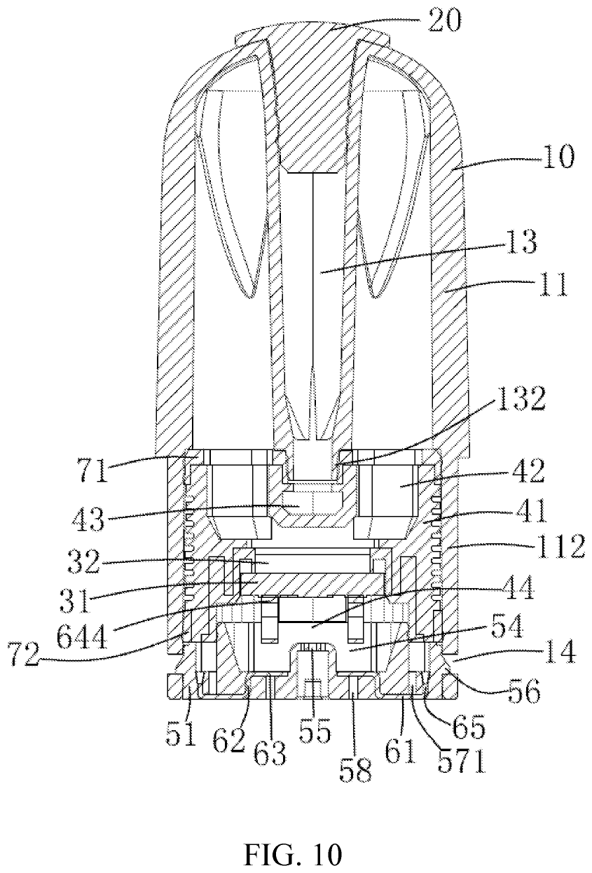

Continuing to refer to FIG. 7 to FIG. 9, the base A includes an insulation base body 50 and elastic terminals 60 integrally formed with the insulation base body 50. The insulation base body 50 includes a substrate 51, a first step 52 formed by extending upward from the substrate 51, a second step 53 formed by extending upward from the first step 52, a recessed portion 54 formed by recessing downward from a middle of the second step 53, and air holes 55 formed by penetrating downward from a middle of the recessed portion 54. Two transverse sides of the first step 52 protrude outward to form second snap-fit portions 56. The two transverse sides of the first step 52 are recessed downward at an outer periphery of the second step 53 to form recessed grooves 57. A surface of the second step 53 is higher than a surface of the first step 52, and the surface of the first step 52 is higher than a surface of the substrate 51. A size of the second step 53 is smaller than a size of the first step 52; that is, the second step 53 is completely located in the first step 52 in a vertical projection direction. The size of the first step 52 is smaller than a size of the substrate 51; that is, the first step 52 is completely located in the substrate 51 in the vertical projection direction. The atomizing cavity 44 of the heating assembly 40 is formed between the recessed portion 54 and the atomizing surface 35 of the atomizing core 30.

The elastic terminal 60 includes a contact portion 61 whose bottom surface is exposed to a lower surface of the substrate 51, a bending portion 62 formed by bending upward and extending from a transverse inner side of the contact portion 61, a support portion 63 formed by bending horizontally and extending from the bending portion 62 along a transverse inner side, and an elastic arm 64 formed by bending upward and extending from a longitudinal side of the support portion 63. The elastic arm 64 includes a vertical arm portion 641 formed by bending upward and extending from the longitudinal side of the support portion 63, a bending arm portion 642 formed by bending from the vertical arm portion 641 along a first longitudinal direction and then bending along a second longitudinal direction, a barb portion 643 formed by bending downward from a top end of the bending arm portion 642, and a contact point portion 644 formed at a top of the bending arm portion 642. The first longitudinal direction is opposite to the second longitudinal direction.

The contact portion 61 is formed inside the substrate 51, and the lower surface of the contact portion 61 is exposed to the lower surface of the substrate 51, so as to be in electrical contact with a battery contact of a cigarette rod. The bending portion 62 is formed in the substrate 51 and the first step 52. The support portion 63 is formed on a bottom surface of the recessed portion 54 of the second step 53, and a surface of the support portion 63 is exposed on a bottom surface of the recessed portion 54. The contact portion 61 and the support portion 63 both have a plate-like structure. The elastic arm 64 is formed by bending upward and extending from the longitudinal side of the support portion 63 after being torn. A first positioning hole 571 is defined on an upper surface of the recessed groove 57 corresponding to the contact portion 61. Through the first positioning hole 571, it is convenient to clamp the contact portion 61 up and down using mold thimbles during injection molding for positioning. A second positioning hole 58 is defined on a lower surface of the substrate 51. The second positioning hole 58 is disposed below the support portion 63, and at least a part of the bottom surface of the support portion 63 is exposed in the second positioning hole 58. Through the positioning hole 58, it is convenient to clamp the support portion 63 up and down using mold thimbles during injection molding for positioning.

The elastic terminal 60 further includes a material connection portion 65 configured to connect to a material strip. A plurality of elastic terminals 60 are connected to one material strip via material connection portions 65, so that fully automated injection molding can be realized in an automated material-pulling mode. Preferably, the material connection portion 65 is formed by bending upward and extending from a transverse outer side of the contact portion 61. In a case that the elastic terminal 60 is press formed, a pre-cut groove is formed between the material connection portion 65 and the material strip. After the insulation base body 50 is injection molded, the material strip is directly broken, which disconnects the material strip from the material connection portion 65 at the pre-cut groove. Specifically, the material connection portion is exposed upwardly to a surface of the recessed groove 57. In other embodiments, the material connection portion may be disposed at other parts of the elastic terminal 60, which may depend on a specific structure of the elastic terminal 60.

After the elastic terminal 60 is injection molded in the insulation base body 50, the insulation base body 50 is pushed from bottom to top into the tube body 11 of the cartridge tube 10. An outer periphery of the substrate 51 is attached to an inner wall surface of the lower tube body 112, and the second snap-fit portions 56 are snapped into the first snap-fit portions 14 to realize latching. An upper surface of the first step 52 abuts against a lower surface of the heating assembly 40, to support the heating assembly 40. The second step 53 partially enters the closure member 40 of the heating assembly 40, to close the atomizing cavity 44. That is, a contour of the second step 53 and the atomizing cavity 44 of the closure member 40 have a profile-modeling structure and may be nested with each other. The contact point portions 644 of the elastic arms 64 of a pair of elastic terminals 60 abut upward against the first electrode 331 and the second electrode 332 of the heating wire 33 disposed on a side of the atomizing surface 35 of the atomizing core 30, to realize electrical contact.

According to the base of the cartridge provided in the present disclosure, the elastic terminal 60 is used to replace the conventional spring-loaded pin, which avoids the problem that the spring-loaded pin cannot connect to materials and thereby failing to realize automated production. The elastic terminal 60 connects to the material strip via the material connection portion 65, so as to realize fully automated injection molding. This greatly reduces labor costs in manufacturing, and enhances production stability, thereby reducing the quality problems caused by human factors.

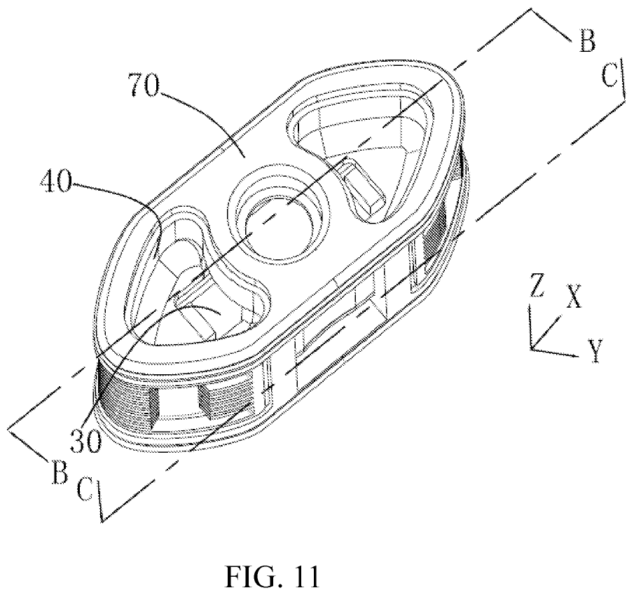

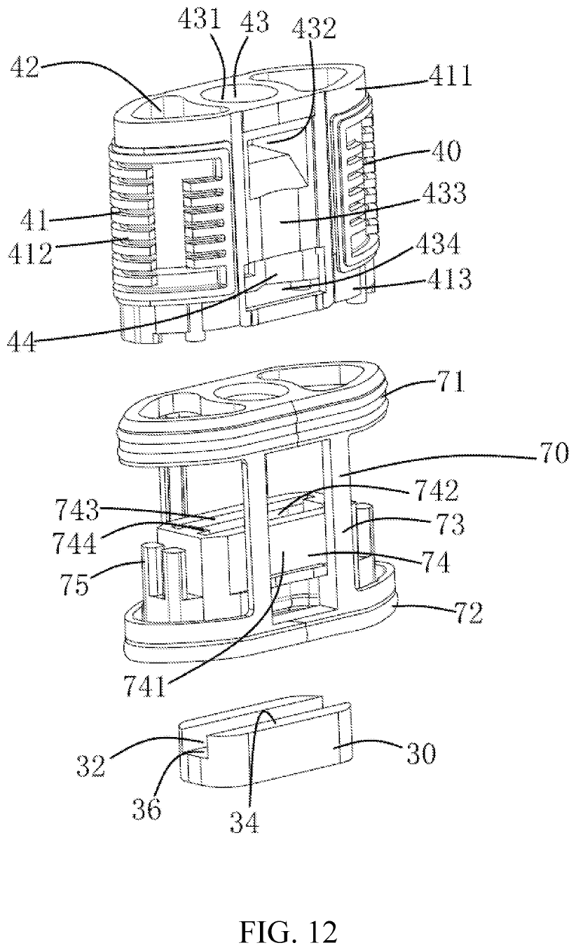

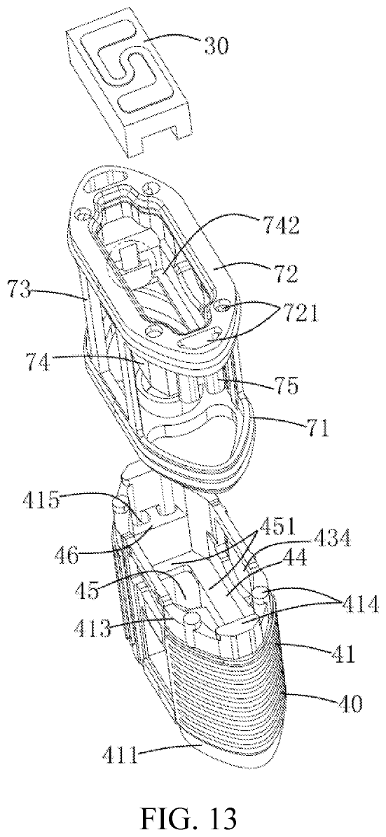

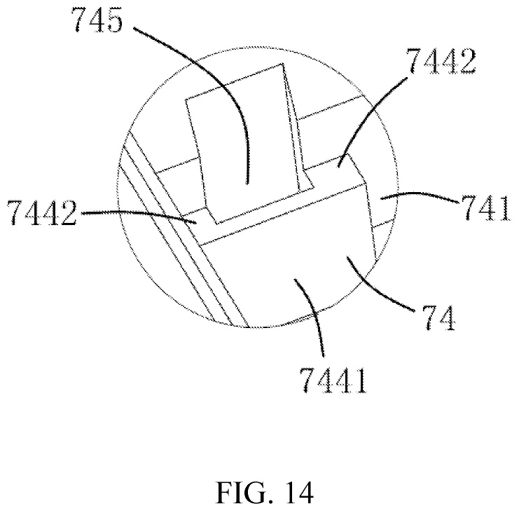

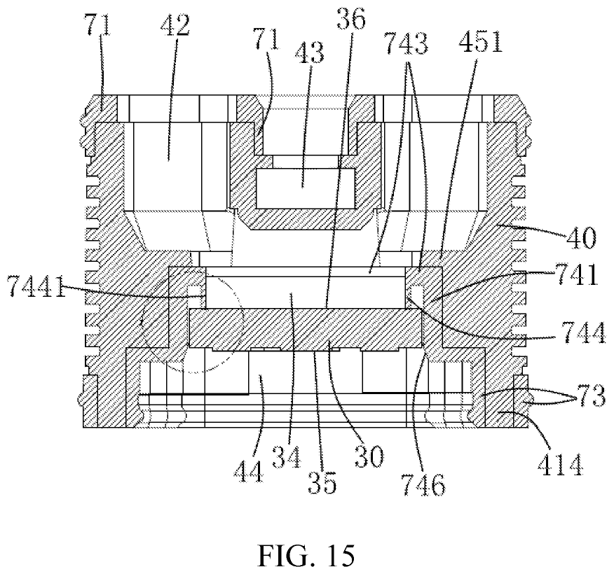

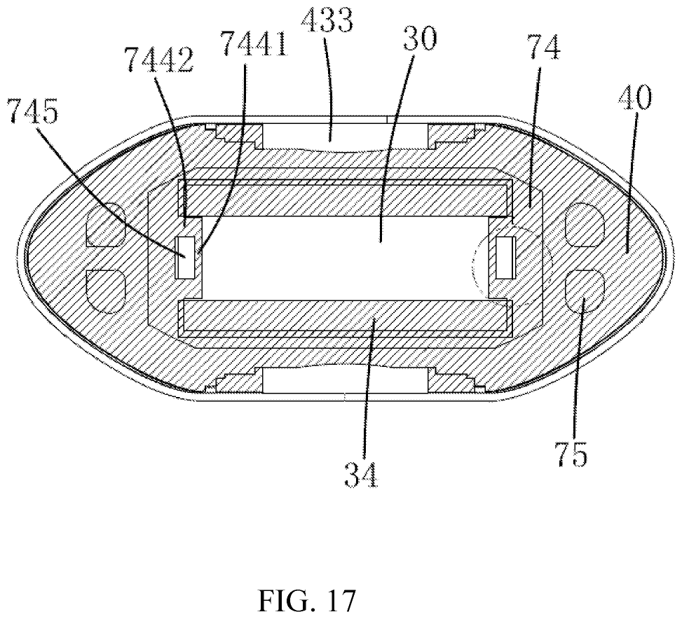

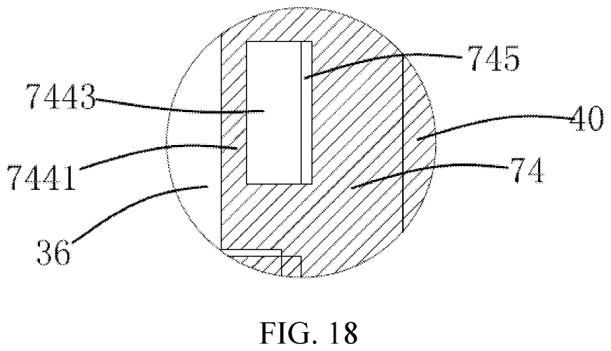

Continuing to refer to FIG. 11 to FIG. 18, the structure and principle of the heating assembly according to a first embodiment of the present disclosure will be detailed below.

The closure member 40 includes a main body portion 41, e-liquid passages 42 defined on two transverse sides of the main body portion 41 in the up-down direction, an accommodation cavity 45 formed in the main body portion 41 and disposed below the e-liquid passages 42, an atomizing cavity 44 defined in the main body portion 41 and disposed below the accommodation cavity 45, and an air passage 43 extending downward from a top of the main body portion 41 and in communication with the atomizing cavity 44.

The main body portion 41 includes a joint end 411 disposed at an upper end and jointing the flue 13 and the liquid storage chamber 12, an accommodation portion 412 disposed below the joint end 411, and a cavity body portion 413 disposed below the accommodation portion 412. The e-liquid passages 42 extend downward from two transverse sides of a top of the joint end 411 and are in communication with the accommodation cavity 45. The accommodation cavity 45 is located inside the accommodation portion 412. The atomizing cavity 44 is located inside the cavity body portion 413. The air passage 43 includes a first air passage 431 formed by recessing downward from a middle of a top of the joint end 411, a second air passage 432 running through the joint end 411 in the front-rear direction in a middle part and in communication with the first air passage 431, a third air passage 433 recessed from two longitudinal sidewalls of the accommodation portion 412 and in communication with the second air passage 432, and a fourth air passage 434 running through a longitudinal sidewall of the cavity body portion 413 and communicating the third air passage 433 to the atomizing cavity 44. The first air passage 431 is located between a pair of e-liquid passages 42. The air passage 43 and the e-liquid passages 42 are isolated and sealed from each other, thereby being independent of each other. A size of the atomizing cavity 44 is larger than a size of the accommodation cavity 45. A peripheral top wall 451 is formed around an outer periphery of a top of the accommodation cavity 45.

A plurality of bumps 414 are disposed at a bottom of the cavity body portion 413 on the periphery of the atomizing cavity 44 of the main body portion 41. Step portions 46 are formed on two transverse sides of the atomizing cavity 44. At least one fit-in hole 415 is defined upward on the step portion 46. The fit-in hole 415 does not run upwardly to the e-liquid passage 42.

The sealing member 70 is formed on the closure member 40. The sealing member 70 includes an upper sealing portion 71 packing the joint end 411, a lower sealing portion 72 packing the cavity body portion 413, a connection portion 73 connecting the upper sealing portion 71 to the lower sealing portion 72, and a packing portion 74 formed in the accommodation cavity 45.

The upper sealing portion 71 packs an outer periphery and a top surface of the joint end 411 and an inner wall surface of the first air passage 431 for sealing. That is, after the heating assembly is placed inside the tube body 11, the upper sealing part 71 is clamped between the outer periphery of the joint end 411 and the inner wall surface of the tube body 11, and between the inner wall surface of the first air passage 431 and the outer wall surface of the insertion portion 132 of the flue tube 13, so as to block the liquid storage chamber 12. As such, sealing is realized between the liquid storage chamber 12 and the outer wall surface of the heating assembly, and between the liquid storage chamber 12 and the air passage 43.

The lower sealing portion 72 packs a bottom surface and an outer side surface of the cavity body portion 413. The lower sealing portion 72 includes a plurality of fit-in holes 721 configured to accommodate the bumps 414 of the closure member 40, and bumps 75 extending into the fit-in holes 415 of the closure member 40, so that the sealing member 70 and the closure member 40 are closely combined without splitting from each other.

The lower sealing portion 72 is clamped between an outer wall surface of the cavity body portion 413 and an inner wall surface of the tube body 11, to realize secondary sealing of the liquid storage chamber 12. In addition, the lower sealing portion 72 is further formed with an inner wall surface covering the atomizing cavity 44. The packing portion 74 extends upward from the lower sealing portion 72 at the inner wall surface of the atomizing cavity 44, and covers an inner wall surface of the accommodation cavity 45 and a bottom surface of the peripheral top wall 451.

The connection portion 73 extends from two transverse sides of the third air passage 433 along the up-down direction, and connects the upper sealing portion 71 to the lower sealing portion 72. The connection portion 73 is clamped between an outer side surface of the main body portion 41 and an inner wall surface of the tube body 11, to seal the air passage 43. In this way, the air passage 43 is independently sealed, and an airflow is sucked only through the atomizing cavity 44.

The packing portion 74 includes a packing wall 741 attached to an inner wall surface of the accommodation cavity 45, a covering portion 743 formed by extending from a top of the packing wall 741 into the accommodation cavity 45, and a fin 744 formed by extending downward from two transverse sides of the covering portion 743. The fin 744 includes a fin main body 7441, a fin longitudinal wall 7442 extending from the packing wall 741 and connecting to the fin main body 7441, and an empty cavity 7443 defined between the fin main body 7441, the fin longitudinal wall 7442 and the packing wall 741. A balance air groove 745 communicating the atomizing cavity 44 to the empty cavity 7443 is defined at a lower part where an inner wall surface of the packing wall 741 is located below the empty cavity 7443.

A thickness of the fin main body 7441 is between 0.15 mm to 0.3 mm, preferably 0.2 mm. A height of the fin main body 7441 is between 0.6 mm to 1.3 mm, preferably 0.9 mm. A width of the fin main body 7441 is between 0.9 mm to 1.5 mm. A longitudinal width of the empty cavity 7443 is 0.9 mm to 1.3 mm. A depth of the balance air groove is between 0.5 mm to 0.3 mm.

After the sealing member 70 and the closure member 40 are integrally injection molded, the atomizing core 30 is inserted from bottom to top into an atomizing core installation cavity 742 of the sealing member 70 disposed in the accommodation cavity 45 of the closure member 40. A chamfer 746 is disposed at an edge of a side where the packing wall 741 is located at the atomizing cavity 44, which facilitates installation of the atomizing core 30. After installation, the packing wall 741 of the sealing member 70 is clamped and sealed by the atomizing core 30 and the accommodation cavity 45. The covering portion 743 is at least partially clamped between surfaces of the extending walls 34 of the atomizing core 30 and the peripheral top wall 451 to achieve sealing. The fin 744 enters down into the transverse through-groove 32. The fin main body 7441 and the fin longitudinal wall 7442 closely press against surfaces of two ends of the transverse through-groove 32. The fin main body 7441 and the fin longitudinal wall 7442 are in interference fit with the transverse through-groove 32. Two longitudinal sides of the fin longitudinal wall 7442 are respectively attached to inner side surfaces of the extension walls 34 at two ends of the transverse through-groove 32 to achieve sealing. After the atomizing core 30 is pressed into the atomizing core installation cavity 7443, the packing wall 741 of the sealing member 70 is partially pressed, which causes a decrease in the depth of the balance air groove 745. However, there still exists a certain margin, so to produce a passage through which the air can pass. Sizes of the fin 744 and the balance air groove 745 may be adjusted and optimized to adapt to different product structures.

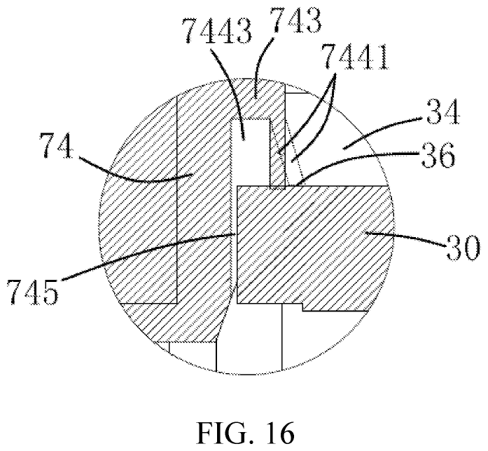

After the e-liquid in the liquid storage chamber 12 is atomized, the liquid storage chamber 12 is in a negative pressure state, which is unfavorable for the e-liquid to continue seeping downward through the atomizing core 30. However, the liquid storage chamber 12 being in the negative pressure state causes the thin fin main body 7441 to tilt inward (as the dotted line shown in FIG. 16), so that there is a certain gap to allow the air to enter the liquid storage chamber 12 through the atomizing cavity 44, the balance air groove 745 and the empty cavity 7443, thereby balancing the air pressure in the liquid storage chamber 12.

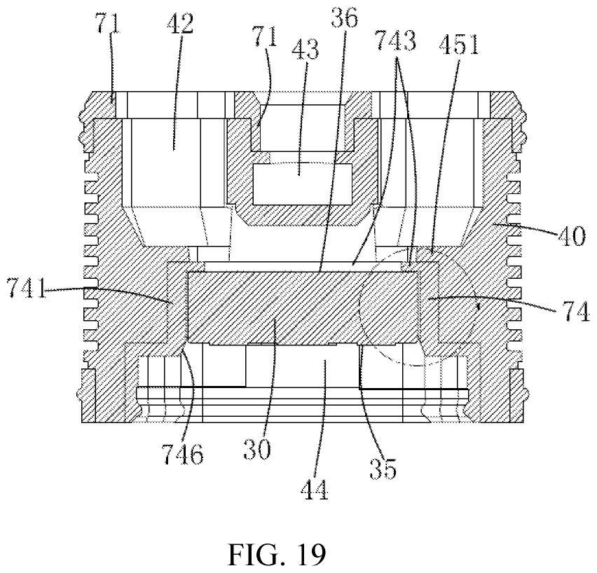

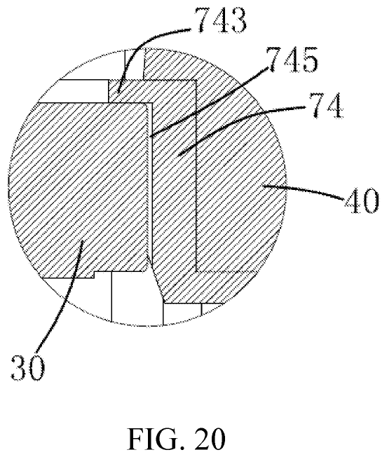

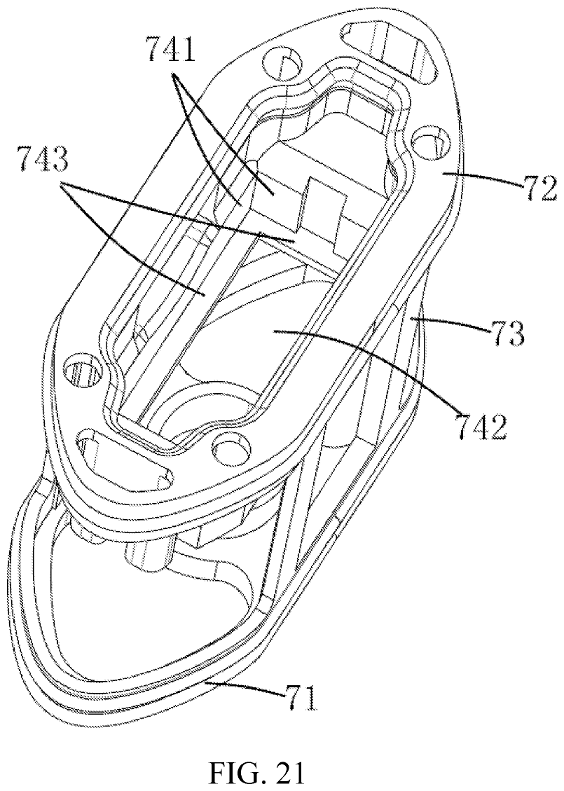

Continuing to refer to FIG. 19 to FIG. 21, which show a heating assembly according to a second embodiment of the present disclosure, the structure and principle of the heating assembly according to the second embodiment of the present disclosure will be detailed below.

The difference between embodiment 2 and embodiment 1 lies in that: the atomizing core 30 has a flat plate structure, that is, the seepage surface 36 of the atomizing core 30 has a plane structure, no transverse through-groove 32 is disposed, and no fin 744 is disposed. The covering portion 743 on the top of the balance air groove 745 covers on a surface of the seepage surface 36. When the liquid storage chamber 12 is in a negative pressure state, the covering portion 743 above the balance air groove 745 is opened upward, and the air in the atomizing cavity 44 is allowed to enter the liquid storage chamber 12 through the balance air groove 745 and the opened covering portion 743, thereby realizing the air pressure balance in the liquid storage chamber 12. The covering portion 743 is in an interference fit with the surface of the atomizing core 30.

In a specific implementation, the packing portion 74 may be arranged separately from the sealing member 70. That is, the packing portion 74 directly packs the atomizing core 30, and then is inserted into the accommodation cavity 45 of the closure member 40.

According to the heating assembly and the cartridge provided in the present disclosure, the balance air groove 745 in communication with the atomizing cavity 44 is defined on the packing wall 741 of the sealing member 70, and the covering portion 743 above the balance air groove 745 completely presses against the seepage surface 36 of the atomizing core 30. As such, when a negative pressure in the liquid storage chamber 12 reaches a certain value, the covering portion 743 is caused to open, so as to allow the air to enter the liquid storage chamber 12 from the atomizing cavity 44 along the balance air groove 745 and the opened covering portion 743, thereby achieving the air pressure balance in the liquid storage chamber 12. In addition, the covering portion 743 is closely attached to the seepage surface 36 of the atomizing core 30 when the liquid storage chamber 12 is in the non-negative pressure state, which can effectively prevent e-liquid leakage.

In addition, the sealing member 70 and the closure member 40 are integrally injection molded, so that they are closely combined. Further, the bumps 414 and 75 are nested with the fit-in holes 415 and 721, which realizes closer combination between the sealing member 70 and the closure member 40. This prevents the sealing member 70 from splitting from the closure member 40, thereby avoiding the quality defects.

What is claimed is:

1. A heating assembly, comprising:
a closure member;
an atomizing core; and
a sealing member, sleeved on the atomizing core and clamped between the atomizing core and the closure member;
wherein the closure member comprises:
a main body portion;
e-liquid passages and an air passage, defined on the main body portion and being independent of each other;
an accommodation cavity, disposed below the e-liquid passages and in communication with the e-liquid passages; and
a part of an atomizing cavity, disposed below the accommodation cavity;
the atomizing core comprises:
a seepage surface in communication with the e-liquid passages; and
an atomizing surface in communication with the atomizing cavity;
wherein the sealing member comprises a packing portion that is closely attached to an interior of the accommodation portion;
the packing portion comprises:
a packing wall, clamped between an inner wall surface of the accommodation cavity and a side surface of the atomizing core; and
a covering portion, extending integrally from the packing wall and being closely attached to an outer edge of the seepage surface;
at least one balance air groove in communication with the atomizing cavity is defined between the packing wall and the side surface of the atomizing core; and
in a case that there is a predetermined negative pressure value in the e-liquid passages, an external air pressure inside the balance air groove causes the covering portion corresponding to the balance air groove to open, and allows external air to enter the e-liquid passage to achieve an air pressure balance.

2. The heating assembly according to claim 1, wherein two transverse sides of a top of the accommodation cavity are in communication with the e-liquid passages;
an opening size of the top of the accommodation cavity is smaller than a size of the accommodation cavity, and a peripheral top wall is formed on a periphery of the top of the accommodation cavity;
the covering portion is at least partially clamped between the peripheral top wall and the seepage surface; and
the covering portion is in an interference fit with the seepage surface.

3. The heating assembly according to claim 2, wherein the peripheral top wall is configured to not press against a side of a covering position where the covering portion covers the seepage surface, wherein the side is close to the balance air groove.

4. The heating assembly according to claim 2, wherein the atomizing core further comprises:
a porous body;
extension walls, formed by extending upward from two longitudinal sides of the porous body; and
a transverse through-groove, defined between the pair of the extension walls;
wherein two ends of the transverse through-groove are in communication with the e-liquid passages, to allow an e-liquid to enter the transverse through-groove.

5. The heating assembly according to claim 4, wherein the packing portion further comprises a fin that extends downward from two transverse sides of the covering portion and presses against a bottom surface of the transverse through-groove, and the balance air grooves are defined on two transverse side surfaces of the atomizing core.

6. The heating assembly according to claim 4, wherein the packing portion further comprises a fin that extends downward from two transverse sides of the covering portion and presses against a bottom surface of the transverse through-groove, and the balance air groove is defined on the packing wall on two transverse sides and corresponds to a position of the fin.

7. The heating assembly according to claim 6, wherein the fin comprises:
a fin main body, pressing downward against a bottom surface of the transverse through-groove; and
a fin longitudinal wall, connecting the fin main body to the packing wall as a whole;
wherein the covering portion, the packing wall, the fin main body and the fin longitudinal wall jointly define an empty cavity with a bottom opening, and the empty cavity is in communication with the balance air groove.

8. The heating assembly according to claim 7, wherein a thickness of the fin main body is less than a thickness of the fin longitudinal wall, the thickness of the fin main body is between 0.15 mm to 0.3 mm, a height of the fin main body is between 0.6 mm to 1.3 mm, and a longitudinal width of the fin main body is between 0.9 mm to 1.5 mm;
a longitudinal width of the empty cavity is greater than a depth of the balance air groove; and
the depth of the balance air groove is less than 0.2 mm after the packing portion is clamped by the atomizing core and the accommodation cavity.

9. The heating assembly according to claim 6, wherein the closure member further comprises a main body portion;
wherein the main body portion comprises:
a joint portion, disposed at an upper end;
an accommodation portion, formed by extending downward from the joint portion; and
a cavity body portion, formed by extending downward from the accommodation portion;
wherein the atomizing cavity is formed in a hollow internal cavity of the cavity body portion, the accommodation cavity is defined in the accommodation portion and disposed above the atomizing cavity, and the e-liquid passages are defined downward from two transverse sides of a top of the joint portion and in communication with the accommodation cavity; and
the air passage comprises:
a first air passage, defined downward from a middle of a top end of the joint portion;
a second air passage, running through the joint portion in a longitudinal direction and in communication with the first air passage;
a third air passage, recessed from two longitudinal sides of the accommodation portion and in communication with the second air passage; and
a fourth air passage, defined from two longitudinal sides of the cavity body portion and communicating the third air passage to the atomizing cavity.

10. The heating assembly according to claim 9, wherein the sealing member is integrally formed on the closure member;
the sealing member further comprises:
an upper sealing portion, formed to pack the joint end;
a lower sealing portion, formed to pack the cavity body portion; and
a connection portion, formed on a longitudinal wall surface of the main body portion along two transverse sides of the second air passage to the fourth air passage;
wherein the covering portion is connected to two transverse sides of the lower sealing portion, the upper sealing portion packs an outer peripheral wall surface of the joint portion and an inner wall surface of the first air passage, the lower sealing portion packs an outer peripheral wall surface of the cavity body portion and a part of an inner wall surface of the atomizing cavity, and the packing portion extends from the lower sealing portion on the inner wall surface of the atomizing cavity into the accommodation cavity.

11. A cartridge, comprising:
a cartridge tube, provided with a flue and a liquid storage chamber;
a closure body, installed in the cartridge tube and closing the liquid storage chamber;
an atomizing core, installed in the closure body; and
a base, fixed to the cartridge tube;
wherein a bottom of the closure body is recessed upward to form a cavity body, an e-liquid passage running through the closure body up and down, and an air passage isolatedly disposed from the e-liquid passage;
the atomizing core is installed inside the cavity body, the flue is in communication with the air passage, and the air passage is in communication with the cavity body below the atomizing core;
the atomizing core comprises:
a seepage surface in communication with the e-liquid passage;
an atomizing surface exposed in the cavity body; and
a heating wire disposed on the atomizing surface;
the heating wire comprises:
a heating wire main body, and
a first electrode and a second electrode, connected to two sides of the heating wire main body;
wherein the base comprises:
an insulation base body; and
an elastic terminal, integrally formed on the insulation base body through injection molding;
wherein the elastic terminal comprises:
a contact portion, exposed to a bottom surface of the insulation base body; and
an elastic arm, abutting upward against and in electrical contact with the first electrode and the second electrode of the atomizing core.

12. The cartridge according to claim 11, wherein the elastic terminal further comprises a material connection portion;
wherein the elastic terminal is connected to a material strip via the material connection portion.

13. The cartridge according to claim 12, wherein a plurality of elastic terminals are connected to a same material strip via the material connection portions, to realize automated material-pulling injection molding of the elastic terminals.

14. The cartridge according to claim 13, wherein the insulation base body comprises:
a substrate;
a first step, formed by extending upward from the substrate;
a second step, formed by extending upward from the first step; and
a recessed portion, formed by recessing downward from a middle of the second step;
wherein an upper part of the recessed portion and a lower part of the cavity body jointly define an atomizing cavity.

15. The cartridge according to claim 14, wherein the elastic terminal further comprises:
a bending portion, formed by bending upward and extending from a transverse inner side of the contact portion; and
a support portion, formed by bending horizontally inward and extending from the bending portion;
wherein the elastic arm is formed by bending upward and extending from a longitudinal side of the support portion; and
the elastic arm comprises:
a vertical arm portion, formed by bending upward and extending from the longitudinal side of the support portion;
a bending arm portion, formed by bending from the vertical arm portion along a first longitudinal direction and then bending and extending along a second longitudinal direction;
a barb portion, formed by bending downward from a free end of the bending arm portion; and
a contact point portion, formed at a top end of the bending arm portion and in electrical contact with the first electrode and the second electrode.

16. The cartridge according to claim 15, wherein a surface size of the first step is smaller than a surface size of the substrate;
a surface size of the second step is smaller than the surface size of the first step;
the first step is recessed downward at an outer side of the second step to form a recessed groove;
a first positioning hole is defined on the recessed groove, to make an upper surface of the contact portion partially exposed in the first positioning hole; and
a second positioning hole is defined on a bottom side of the substrate, to make a bottom surface of the support portion partially exposed in the second positioning hole.

17. The cartridge according to claim 16, wherein the closure body installed with the atomizing core is inserted upward into the tube body of the cartridge tube;
the base is inserted upward into the tube body and disposed below the closure body;
an inner wall of a cavity body of the closure body and an outer wall of the second step are of a profile-modeling structure;
the second step is snappable into the cavity body of the closure body to close the atomizing cavity;
a bottom of the closure body abuts against the first step of the base;
an outer periphery of the substrate is attached to an inner wall surface of the tube body; and
a first snap-fit portion and a second snap-fit portion in snap-fit with each other are disposed on the tube body and the base respectively, so as to be snapped with each after the base is inserted.

18. The cartridge according to claim 11, wherein the atomizing core further comprises:
a ceramic substrate;
extension walls, formed by extending upward from two longitudinal sides of the ceramic substrate; and
a transverse through-groove, defined between the pair of the extension walls;
wherein two ends of the transverse through-groove are in communication with the e-liquid passage, to allow an e-liquid to enter the transverse through-groove.

19. A cartridge, comprising:
an atomizing core;
a tube body;
a closure member;
a sealing member integrally formed on the closure member; and
a base;
wherein the atomizing core comprises:
a porous body;
extension walls, formed by extending upward from two longitudinal sides of the porous body; and
a transverse through-groove, defined between the pair of the extension walls;
a seepage surface is formed at a bottom surface of the transverse through-groove, an atomizing surface is formed at a bottom surface of the porous body, and a heating wire is disposed on the atomizing surface;
the closure member comprises:
a main body portion;
an e-liquid passage and an air passage, defined on the main body portion and being independent of each other;
an accommodation cavity, disposed below the e-liquid passage and in communication with the e-liquid passage; and
a part of an atomizing cavity, disposed below the accommodation cavity;
the sealing member comprises:
an upper sealing portion and a lower sealing portion, clamped between the tube body and the closure member; and
a packing portion, formed in the accommodation cavity;
wherein the packing portion is clamped between the atomizing core and the accommodation cavity;
the covering portion comprises:
a packing wall, clamped between an outer side surface of the atomizing core and an inner wall surface of the accommodation cavity; and
a covering portion, extending from the packing wall and pressing against the seepage surface in an interference manner.

20. The cartridge according to claim 19, wherein at least one balance air groove in communication with the atomizing cavity is defined between the packing wall and a side surface of the atomizing core, and in a case that there is a predetermined negative value in the e-liquid passage, an external air pressure inside the balance air groove causes the covering portion corresponding to the balance air groove to open, and allows external air to enter the e-liquid passage to achieve an air pressure balance.
